(19) United States
(12) Patent Application Publication
(10) Pub. No.: US 2004/0128302 A1
(43) Pub. Date: Jul. 1, 2004

(54) System and method for controlling privacy in common-item discovery system

(76) Inventors: Andrew L. Schirmer, Andover, MA (US); Marijane M. Zeller, Medford, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/335,237

(22) Filed: Dec. 31, 2002

(51) Int. Cl. G06F 17/00

(52) U.S. Cl. 707/101

(57) ABSTRACT

The invention relates generally to protecting privacy in a common item discovery system. More particularly, the invention provides a method for protecting privacy in a common item discovery system, the method comprising identifying an item instance in common between two or more parties and filtering, according to privacy preferences associated with each party, indication of the identified item instance as common to the parties.

### COPYRIGHT NOTICE

A portion of the disclosure of this patent document contains material which is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

The invention disclosed herein relates generally to information privacy and more particularly to protecting a user's association with an item instance in a common item discovery system.

Systems currently exist to discover and make known information of interest that is common to two or more people. For example, both people may have the same job title or be knowledgeable in a certain field of expertise. Such information can be useful in expertise location systems which help people find others of interest to them by searching for those that match one or more characteristics or other selection criterion. Another use of such a system is to facilitate making connections between two unconnected people by presenting them with a list of people that they have in common such as people they work with or otherwise know thus enabling them to make the connection through a known intermediary. Within such systems, many such “information in common” pairings are possible. For example, given a set of people A, B, and C, a system could discover information in common between A and B, between B and C, and between A and C.

One problem with such systems is that they make visible information about people that might otherwise be hidden or hard to discover. In some cases, this is not a significant drawback where the information is already generally public such as a job title. In other cases, however, such disclosure can be problematic. For example, when a system derives information from characteristics that are more sensitive or about relationships to other people, the privacy of the subjects is at stake. A person might not want to make known their association with a psychiatrist for example. Additionally, arbitrarily exposing information about relationships between people can sometimes provide irrelevant or misleading information for the purposes of the system.

There is thus a need for methods, systems, and software products to provide options for privacy in a common item discovery system.

### SUMMARY OF THE INVENTION

The present invention addresses, among other things, the problems discussed above identifying related to privacy protection in a common item discovery system.

In accordance with some aspects of the present invention, methods are provided for protecting privacy in a common item discovery system, the method comprising identifying an item instance in common between two or more parties and filtering, according to privacy preferences associated with each party, indication of the identified item instance as common to the parties. In some embodiments, the identified item represents a relationship with another party or an activity. In some embodiments, the identifying is in response to a request by a user of the common item discovery system or a batch process of the common item discovery system.

In some the method comprises storing the privacy preferences associated with each party as a list associated with each party. In some embodiments, the method comprises allowing privacy preferences associated with a party to be specified by the party. In some embodiments, the method comprises filtering differently according to the identity of a user of the common item discovery system. For example, a party might permit their manager to view their association with an item, but not their coworkers. In some embodiments, the method comprises making known, to one or more users of the common item discovery system, that the identified item instance is common to the parties.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing a computer system for controlling privacy in a common item discovery system in accordance with one embodiment of the present invention;

FIG. 2 is a flow chart showing a method of controlling privacy in a common item discovery system in accordance with one embodiment of the invention;

FIG. 3 is a block diagram showing a method of controlling privacy for two people in a common item discovery system in accordance with one embodiment of the invention;

FIG. 4 is a flow chart showing a method of indicating privacy settings for sensitive item instances in a common item discovery system in accordance with the present invention;

FIG. 5 is a flow chart showing a method of publishing item instances in common between parties in a common item discovery system in accordance with one embodiment of the invention;

FIG. 6 presents an example of a sensitive item instance list according to one embodiment of the invention; and

FIG. 7 presents another example of a sensitive item instance list according to one embodiment of the invention.

### DETAILED DESCRIPTION

In accordance with the invention, item instances in common between multiple parties are published according to privacy settings specified by each individual party. Two or more parties might have an item instance in common, however, a party can, by specifying privacy settings, elect not to make known that they are associated with that item instance and thus the other party. The privacy election process is further described herein.

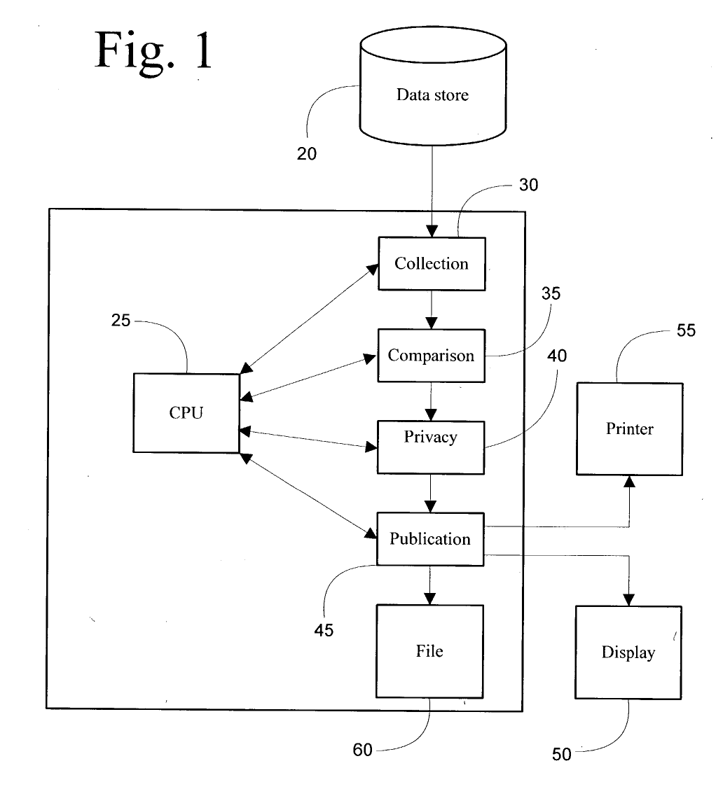

A system and method of preferred embodiments of the present invention are now described with reference to FIGS. 1-5. Referring to FIG. 1, a system 10 of one embodiment of the present invention includes a computer system 15, which may be a personal computer, networked computers, or other conventional computer architecture. The system 10 includes a processor 25 and at least one data store 20 such as a database or other memory structure which may be stored in volatile memory, non-volatile memory, a hard disk, a network-attached storage device, or other storage media as known in the art. In some embodiments, the data store 20 may include multiple databases and other memory structures stored in multiple locations in a network computing environment.

In accordance with the present invention, a number of software programs or program modules or routines reside and operate on the computer system 15. These include a collection engine 30, a comparison engine 35, a privacy engine 40, and a publishing engine 45. The system 10 also contains one or more output devices which may include a display 50 such as a computer monitor or flat panel display, a printer 55, a memory device 60, and other conventional output devices known in the art. In some embodiments, the memory device 60 may include volatile memory, nonvolatile memory, a file system, a hard disk drive, network attached storage, and other memory devices known in the art. In some embodiments, the memory device 60 may be associated with or otherwise a part of the data store 20.

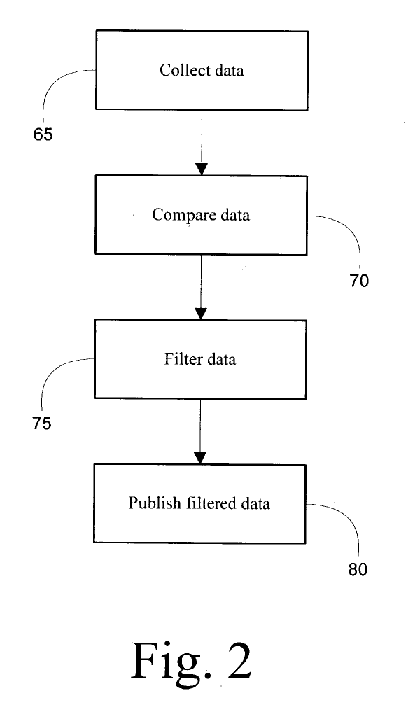

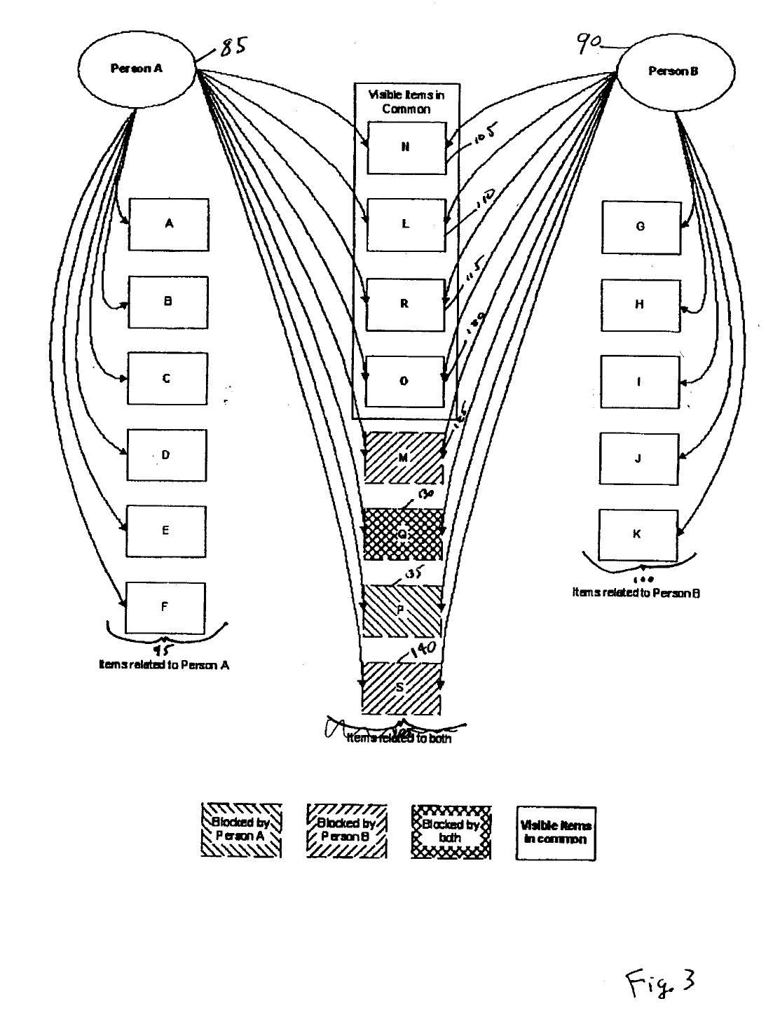

Referring to FIG. 2 and FIG. 3, in a method of controlling privacy in a common item discovery system according to an embodiment of the invention, the collection engine 30 retrieves data from the data store 15, step 65. A common item discovery system indicates item instances that two or more parties have in common. For example, a first person 85 (FIG. 3) and a second person 90 are associated with a number of different item instances. Item types include people, places, things, activities, experiences, preferences, roles, functions, files, data, and other similar distinguishers useful in classifying commonalities. Item instances, by contrast, are specific examples of item types. Thus, within each item type, there can be one or more values representing item instances. For example, Bob Jones, an individual's psychiatrist, might be an item instance of the item type doctors, and Fred Jones, an individual's cardiologist, might be another item instance of the item type doctors.

As shown, the first person 85 is solely associated with a number of item instances A-F 95 and the second person 90 is solely associated with a number of different item instances G-K 100. Neither the first person 85 nor the second person 90 have any of the item instances 95 and 100 in common. On the other hand, the first person 85 and the second person 90 do have a number of other item instances in common including item instance N 105, item instance L 110, item instance R 115, item instance 0 120, item instance M 125, item instance Q 130, item instance P 135, and item instance S 140.

A common item discovery system would therefore indicate that the first person 85 and the second person 90 have in common item instance N 105, item instance L 110, item instance R 115, item instance 0 120, item instance M 125, item instance Q 130, item instance P 135, and item instance S 140. According to embodiments of the present invention, the system 10, using the comparison engine 35, determines that two or more parties have item instances in common by comparing all item instances associated with either party, step 70. In the example of FIG. 3, therefore, the collection engine 30 passes to the comparison engine 35 a list of all item instances A-S associated with either the first person 85 or the second person 90. The comparison engine 35 then determines which item instances are common to both the first person 85 and the second person 90 by comparing item instances associated with the first person 85 to the item instances associated with the second person 90, step 70. In some embodiments, the comparison engine 35 creates an interim list or data structure in memory to store the list of all item instances in common.

The privacy engine 40 filters each item instance according to privacy settings specified by the party or parties with whom the item instance is associated, step 75. A party might wish to keep their association with a particular item instance secret and thus set their privacy settings accordingly. For example, the first party 85 and the second party 90 might share the same psychiatrist, but the first party might not wish their association with the psychiatrist to be publicly known. As another example, a company might wish to keep secret the associations between certain users and certain data files since publishing the item instances in common between these users might provide unwelcome insight into the company's research activities or other activities.

The system 10 includes an approval system whereby users can specify which item instances and item types they are willing to make their association with known publicly. Item types provide a useful way of categorizing and classifying information at a high level in a common item discovery system. For example, some item types may not be considered sensitive by some users. Rather than have users specify privacy preferences for every item instance with which they are associated, in some embodiments, users need only specify privacy preferences for item instances associated with item types considered sensitive or otherwise impacting a user's privacy.

Thus, in some embodiments, certain item instances in the system 10 are considered sensitive item instances that will be filtered by the privacy engine 40 and other item instances are considered public or insensitive item instances and thus not subject to filtering by the privacy engine 40. For example, a system administrator could setup the privacy engine to filter item instances associated with sensitive item types. In some embodiments, the system 10 utilizes an opt-in system by default for sensitive item instances or item types such that a person must affirmatively indicate that they wish their association with a particular sensitive item instance or item type to be made public. In other embodiments, the system 10 utilizes an opt-out system by default for sensitive item instances or item types such that a person must affirmatively indicate that they do not wish their association with a particular sensitive item instance or item type to be made public. In still other embodiments, the system 10 supports a sliding authorization system that may be based on a variety of factors such as the identity or role of the person able to view the association or other similar factors. For example, the system 10 could allow an person to specify as a privacy setting for a particular item instance or item type that only a manager would be able to view that person's association with the item instance or item type.

Thus in the example of FIG. 3, the first person 85 and the second person 90 have in common item instance N 105, item instance L 110, item instance R 115, item instance 0 120, item instance M 125, item instance Q 130, item instance P 135, and item instance S 140. However, item instance M 125, item instance Q 130, item instance P 135, and item instance S 140 are subject to privacy settings specified by the first person 85 or the second person 90. For example, the first person 85 has elected not to disclose their association with item instance P 135, the second person 90 has blocked access to their association with item instance M 125 and item instance S 140, and both parties have blocked access to their association with item instance Q 130. Neither party has indicated privacy settings to block their associations with item instance N 105, item instance L 110, item instance R 115, and item instance 0 120, thus the privacy engine 40 would not block disclosure of these associations and the publishing engine 45 would publish these item instances as item instances in common between the parties, step 80.

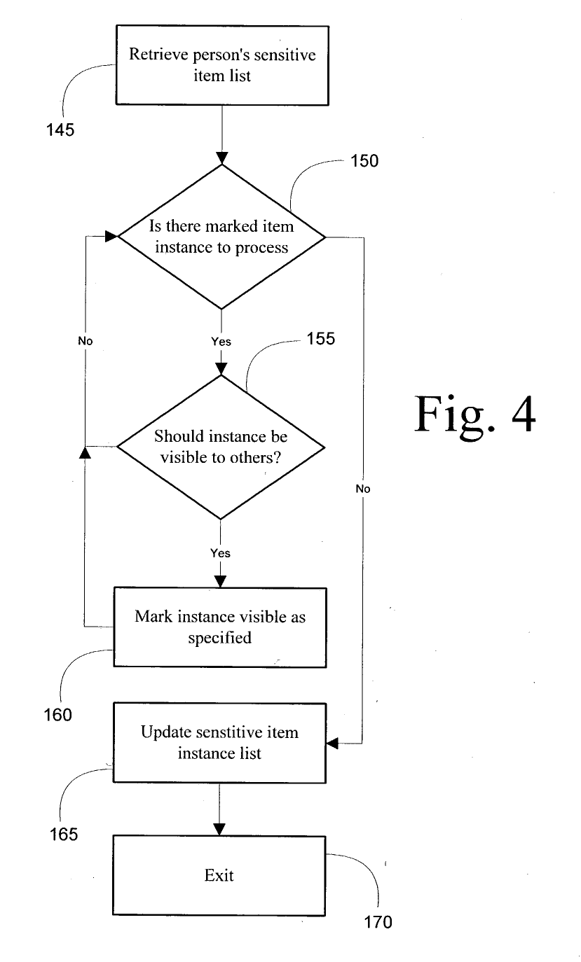

FIG. 4 presents a flow chart showing a method of indicating privacy settings for sensitive item instances in a common item discovery system in accordance with the present invention. The collection engine 30 retrieves a person's sensitive item instance list from the data store 20 or other memory, step 145. The sensitive item instance list, as further described herein, is a list or other data structure containing item instances associated with a user. In some embodiments, the sensitive item instance list is stored in the data store 20 or other memory. In some embodiments, the sensitive item instance list distinguishes those item instances which should be filtered by the privacy engine 40 from item instances which are by default allowed to be publicly known and not subject to filtering. In some embodiments, for example in “opt-in” systems, the item instances on the sensitive item instance list are, by default, not allowed to be publicly known. In other embodiments, for example in “opt out” systems, the item instances on the sensitive item instance list are, by default, publicly known. In some embodiments, a sensitive item instance list can be preconfigured by a system administrator or other entity to include only certain item types. In some embodiments, the system 10 uses a plurality of sensitive item instance lists corresponding to individual users of the system 10. In other embodiments, the system 10 uses a single sensitive item instance list containing a list of all items with data associating the items with individual users and individual privacy preferences associated with the individual users.

The privacy engine 40 determines whether there are any item instances to process, step 150. If there are item instances to process, the system 10 queries the user or otherwise requests input to determine whether the user's association with the first such item instance should be publicly accessible and visible to others, step 155. In some embodiments, for example in a sliding authorization system, the user can specify varying degrees of public access to the user's association with an item instance. If the user indicates that their association with an item instance should not be publicly accessible or known, then the control returns to step 150 to determine if there are other item instances to process. Otherwise, the system 10 marks the item instance visible as specified, step 160, and then control returns to step 150 to determine if there are other item instances to process. When there are no further item instances on the sensitive item instance list to be processed, the sensitive item instance list is updated and the routine exits, step 165. In some embodiments, the system 10 may process only a portion of the sensitive item instance list at one time. For example, a user might elect to only indicate preferences for a item instances of a particular item type rather than for all item instances on their sensitive item instance list.

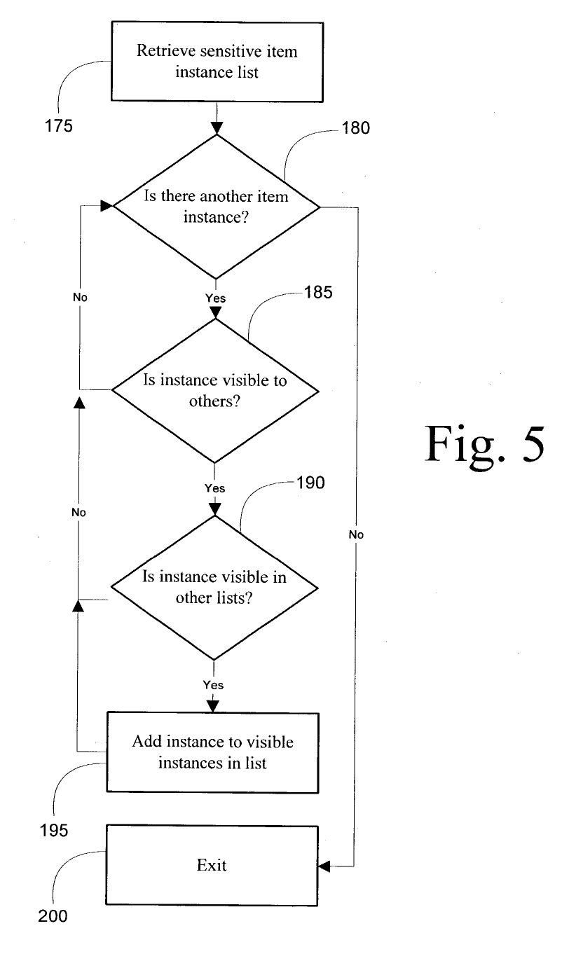

FIG. 5 is a flow chart showing a method of publishing item instances in common between parties in a common item discovery system in accordance with one embodiment of the invention. The method compares the sensitive item instance lists of two or more parties to determine whether there are item instances in common associated with and between the parties that may be made publicly accessible. In some embodiments, the method is performed in real-time, for example upon user request. In other embodiments, the method is performed as a batch process, for example on a daily basis as part of regularly scheduled data maintenance.

The collection engine 30 retrieves the first person's sensitive item instance list from the data store 20 or other memory, step 175. The privacy engine 40 determines whether there are any item instances to process on the list, step 180. If there are item instances to process, the privacy engine 40 evaluates the privacy settings accorded to a first such item instance to determine whether the user's association with the item instance should be publicly accessible and visible to others, step 185. If the item instance's privacy settings indicate that the user's association with the item instance should not be publicly accessible or known, then the control returns to step 180 to determine if there are other item instances to process.

The privacy engine 40 evaluates the privacy settings for the item instance specified in the sensitive item instance lists of the other parties to determine whether the other parties' association with the item instance should be publicly accessible and visible to others, step 190. In some embodiments, the collection engine 30 retrieves the sensitive item instance lists of the other parties from the data store 20 or other memory for evaluation. If the item instance's privacy settings indicate that the other parties' association with the item instance should not be publicly accessible or known, then the control returns to step 180 to determine if there are other item instances to process. Otherwise, the system 10 adds the item instance to a visible item instances in common list, step 195, and then control returns to step 180 to determine if there are other item instances to process. The visible item instances in common list is a list or other data structure containing item instances associated with common users and which are publicly visible or otherwise accessible to other users of the common item discovery system. When there are no further item instances to process, the routine exits, step 200.

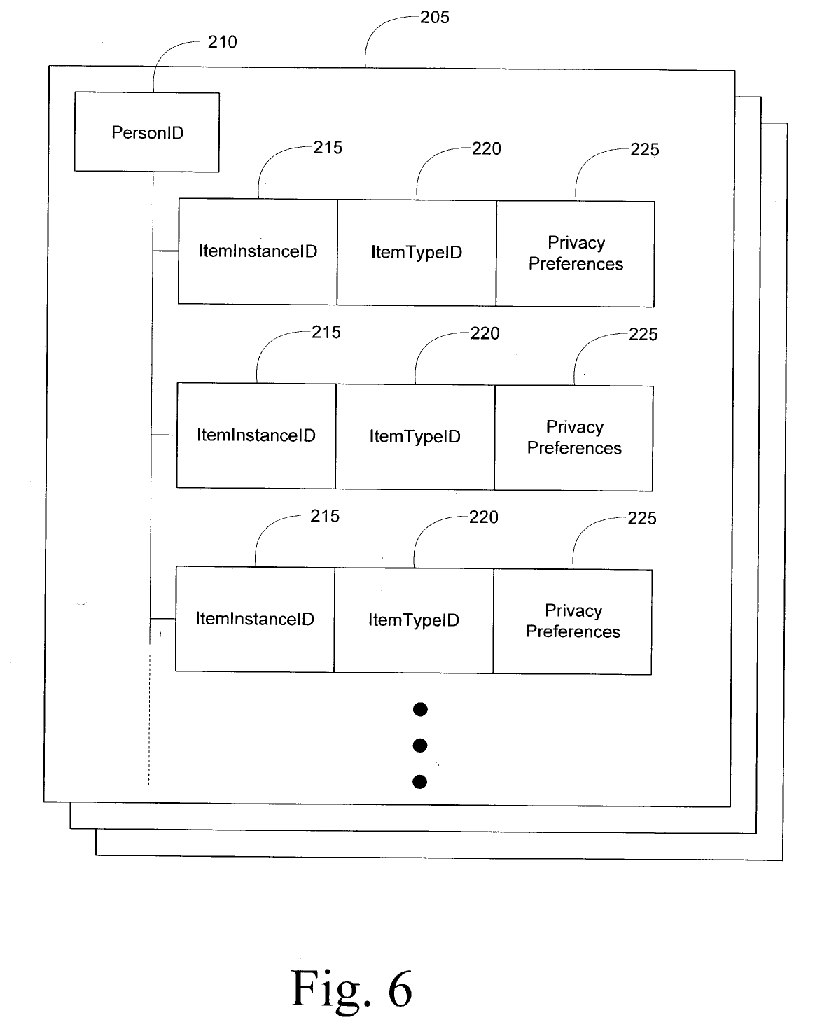

FIG. 6 presents an example of a sensitive item instance list according to one embodiment of the invention. The sensitive item instance list includes a data structure 205 containing a number of fields or variables including a Person ID field 210, an item instance ID field 215, an item type ID field 220, and a privacy preferences field 225. In some embodiments, as shown here in FIG. 6, the system 10 uses a plurality of sensitive item instance lists each corresponding to individual users of the system 10. Thus, the data structure 205 uniquely corresponds to the user associated with the person ID field 210. The person ID field 210 is a unique value which permits the system 10 to, among other things, distinguish between users of the common item discovery system and distinguish privacy preferences for these users with respect to item instances. Each user, represented by a person ID field 210, is associated with one or more item instances. Each item instance in the data structure 205 is uniquely identified by an item instance ID field 215 which is further associated with an item type ID field 220 and privacy preferences field 225. The item type ID field 220 is a unique value which permits the system 10 to, among other things, distinguish between item types and also perform searches of item instances according to item types. The privacy preferences field 225 stores values indicating the privacy preferences for the item instance associated with the item instance ID field 215 that the user associated with the person ID field 210 has selected.

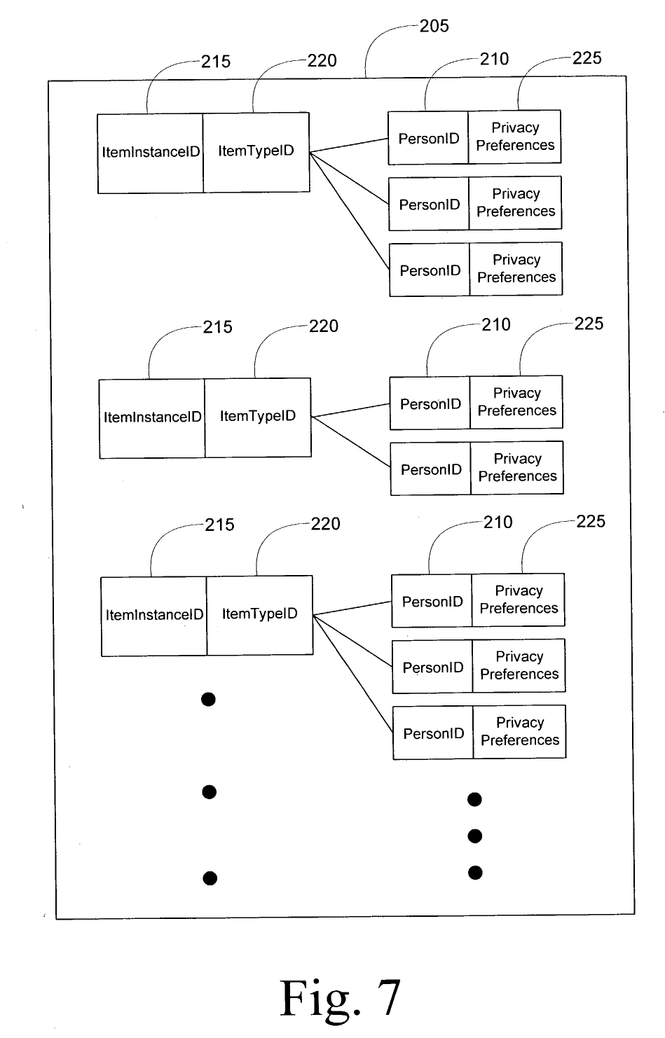

FIG. 7 presents another example of a sensitive item instance list according to one embodiment of the invention. The sensitive item instance list includes a data structure 205 containing a number of fields or variables including an item instance ID field 215, an item type ID field 220, a Person ID field 210, and a privacy preferences field 225. In some embodiments, as shown here in FIG. 7, the system 10 uses a single sensitive item instance list containing information about a plurality of item instances with information corresponding to their associated users and the privacy preferences of those users. Thus, the data structure contains a information about a plurality of item instances corresponding to item instances associated with each item instance ID field 215. Each item instance ID field 215 is further associated with an item type ID field 220 and one or more users of the common item discovery system. The users associated with each item instance are represented by a person ID field 210 and a privacy preferences field 225.

In other embodiments, the system 10 uses a single sensitive item instance list containing a list of all items with data associating the items with individual users and individual privacy preferences associated with the individual users.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for protecting privacy in a common item discovery system, the method comprising:
identifying an item instance in common between two or more parties;
filtering, according to privacy preferences associated with each party, indication of the identified item instance as common to the parties.

2. The method of claim 1, wherein the item instance represents a relationship with another party.

3. The method of claim 1, wherein the item instance represents an activity.

4. The method of claim 1, wherein the identifying is in response to a request by a user of the common item discovery system.

5. The method of claim 1, wherein the identifying is a batch process of the common item discovery system.

6. The method of claim 1, wherein the method comprises storing the privacy preferences associated with each party as a list associated with each party.

7. The method of claim 1, wherein the method comprises allowing privacy preferences associated with a party to be specified by the party.

8. The method of claim 1, wherein the method comprises filtering differently according to the identity of a user of the common item discovery system.

9. The method of claim 1, wherein the method comprises making known, to one or more users of the common item discovery system, that the identified item instance is common to the parties.

10. A system for protecting privacy in a common item discovery system, the system comprising:
a data store containing an item instance; and
a computer connectable to the data store;
wherein the computer is programmed to identify an item instance in common between two or more parties; and to filter, according to privacy preferences associated with each party, indication of the identified item instance as common to the parties.

11. The system of claim 10, wherein the computer is programmed to identify an item instance representing a relationship with another party.

12. The system of claim 10, wherein the computer is programmed to identify an item instance representing an activity.

12. The system of claim 10, wherein the computer is programmed to identify in response to a request by a user of the common item discovery system.

13. The system of claim 10, wherein the computer is programmed to identify as a batch process of the common item discovery system.

14. The system of claim 10, wherein the computer is programmed to store the privacy preferences associated with each party as a list associated with each party.

15. The system of claim 10, wherein the computer is programmed to allow privacy preferences associated with a party to be specified by the party.

16. The system of claim 10, wherein the computer is programmed to filter differently according to the identity of a user of the common item discovery system.

17. The system of claim 10, wherein the computer is programmed to make known, to one or more users of the common item discovery system, that the identified item instance is common to the parties.

18. A computer usable medium storing program code which, when executed on a computerized device, causes the computerized device to execute a computerized method for protecting privacy in a common item discovery system, the method comprising:
identifying an item instance in common between two or more parties;
filtering, according to privacy preferences associated with each party, indication of the identified item instance as common to the parties.
